(19) United States
(12) Patent Application Publication
(10) Pub. No.: US 2011/0064435 A1
(43) Pub. Date: Mar. 17, 2011

(54) IMAGE FORMING APPARATUS AND IMAGE FORMING METHOD

(75) Inventors: Masashi Takahashi, Kanagawa-ken (JP); Takao Izumi, Kanagawa-ken (JP); Hiroshi Murata, Tokyo-to (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/872,016

(22) Filed: Aug. 31, 2010

Related U.S. Application Data
(60) Provisional application No. 61/242,993, filed on Sep. 16, 2009.

(51) Int. Cl. G03G 15/10; G03G 13/10

(52) U.S. Cl. 399/58

(57) ABSTRACT

According to one embodiment, an image forming apparatus includes a supply device that supplies developer includes toner and carrier, a developing device configured to accommodate the developer includes toner and carrier in a manner that the developer is stirred and transported therein, and configured to discharge the developer in an overflow manner through a discharge opening, a screw that stirs and transports the developer in the developing device, and a control unit configured to change the rotation speed of the screw based on a predetermined index which varies in accordance with supply and consumption of the developer or an environmental condition when development is performed.

### CROSS-REFERENCE TO RELATED APPLICATIONS

This application is based upon and claims the benefit of U.S. Provisional Application No. 61/242,993 filed on Sep. 16, 2009; the entire contents of which are incorporated herein by reference.

### FIELD

Embodiments described herein relate generally to an image forming apparatus and an image forming method.

### BACKGROUND

Conventionally, various developing devices are used in an image forming apparatus such as a copier and a printer. For example, a developing device that performs development using a two-component developer is used. In general, a developing device that uses a two-component developer composed of toner and carrier supplies toner which is consumed by a developing operation.

A conventional developing device mixes a small amount of carrier into a toner cartridge and supplies the carrier together with toner. A discharge opening for discharging developer is formed in the developing device, and developer is discharged through the discharge opening. By doing so, the developer is replaced automatically, and maintenance for developer replacement is not necessary.

In this developing device, the supply of carrier is carried out at the same time as the supply of toner. When an image having a high print ratio is continuously printed on a number of pages, the amount of developer supply will increase, and the amount of developer in the developing device will increase. Particularly, when the amount of developer under a developing roller increases, developer which was already used for development will be provided again for development as it was by the rotation of the developing roller. This phenomenon is one of the causes of image deterioration such as density unevenness of solid images.

On the contrary, when an image having a low print ratio is continuously printed, the amount of developer supply will decrease. Thus, the amount of developer discharge becomes larger than the amount of supply, and the amount of developer in the developing device decreases. As a result, density unevenness occurs in solid images.

Further, the amount of developer discharge changes with aging of the developer, a change in mobility of the developer in accordance with the use environment, and the like. As a result, the amount of developer in the developing device changes, and problems are caused in an image.

### BRIEF DESCRIPTION OF THE DRAWINGS

FIG. 1 is a schematic diagram showing an exemplary configuration of a color printer which is an image forming apparatus according to an embodiment.

FIG. 2 is a perspective view showing an exemplary configuration of a developing device according to the embodiment.

FIG. 3 is a sectional view showing an exemplary combination of a developing device and a toner supply hopper according to the embodiment.

FIG. 4 is a sectional view illustrating an exemplary operation of the developer in the developing device according to the embodiment.

FIG. 5 shows an exemplary evaluation result of a print ratio and image density unevenness according to the embodiment.

FIG. 6 is an exemplary flowchart showing a control method of the developing device according to the embodiment.

FIG. 7A is an exemplary diagram showing the number of prints and the amount of developer in the developing device for each print ratio when no control is performed according to the embodiment.

FIG. 7B is an exemplary diagram showing the number of prints and the amount of developer in the developing device for each print ratio when control is performed according to the embodiment.

FIG. 8 is an exemplary flowchart showing a control method of a developing device according to a second embodiment.

FIG. 9 is an exemplary flowchart showing a control method of a developing device according to a third embodiment.

FIG. 10 is an exemplary flowchart showing a control method of a developing device according to a modification of the third embodiment.

FIG. 11 is an exemplary flowchart showing a control method of a developing device according to a fourth embodiment.

FIG. 12 is an exemplary flowchart showing a control method of a developing device according to a seventh embodiment.

FIG. 13 is a block diagram showing an exemplary control system that controls the rotation speed of a transport screw of each developing device according to an embodiment.

### DETAILED DESCRIPTION

In general, according to one embodiment, an image forming apparatus includes a supply device that supplies developer comprising toner and carrier; a developing device configured to accommodate the developer comprising toner and carrier in a manner that the developer is stirred and transported therein, and configured to discharge the developer in an overflow manner through a discharge opening;

a screw that stirs and transports the developer in the developing device; and a control unit configured to change the rotation speed of the screw based on a predetermined index which varies in accordance with supply and consumption of the developer or an environmental condition when development is performed.

Hereinafter, a first embodiment of the present invention will be described.

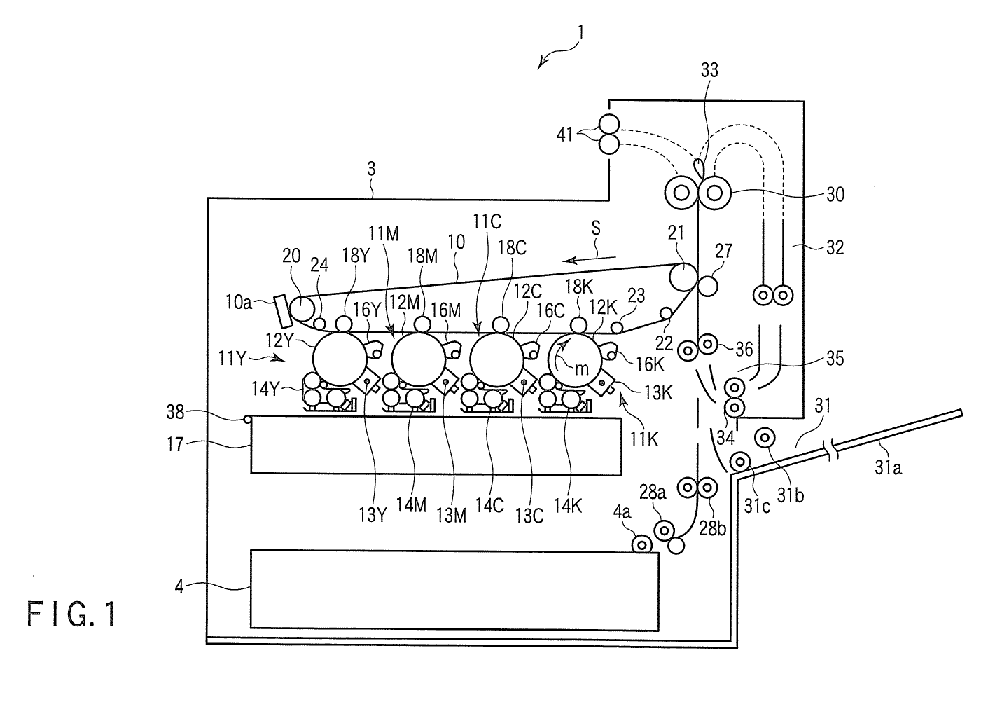

FIG. 1 is a schematic diagram showing an exemplary configuration of a color printer 1 which is an image forming apparatus according to an embodiment. The color printer 1 is a 4-drum tandem-type color printer.

The color printer 1 includes a paper discharge portion 3 on the upper side thereof. The color printer 1 includes an image forming unit 11 on the lower side of an intermediate transfer belt 10. The image forming unit 11 includes four process units 11Y, 11M, 11C, and 11K which are arranged in parallel along the intermediate transfer belt 10. The process units 11Y, 11M, 11C, and 11K form toner images of the respective colors yellow (Y), magenta (M), cyan (C), and black (K).

The process units 11Y, 11M, and 11C, and 11K include photoconductive drums 12Y, 12M, 12C, and 12K, respectively, which are image carrying members. The photoconductive drums 12Y, 12M, 12C, and 12K are rotatable in the direction indicated by arrow m. Around the photoconductive drums 12Y, 12M, 12C, and 12K, electrification chargers 13Y, 13M, 13C, and 13K, developing devices 14Y, 14M, 14C, and 14K, and photoconductor cleaners 16Y, 16M, 16C, and 16K are arranged along the rotation direction thereof. The electrification chargers 13Y, 13M, 13C, and 13K uniformly charge the photoconductive drums 12Y, 12M, 12C, and 12K to a negative (−) polarity.

Areas extending from the electrification chargers 13Y, 13M, 13C, and 13K to the developing devices 14Y, 14M, 14C, and 14K around the photoconductive drums 12Y, 12M, 12C, and 12K are irradiated with exposure light by a laser exposure device 17. By the irradiation of the exposure light, electrostatic latent images are formed on the photoconductive drums 12Y, 12M, 12C, and 12K. The electrification chargers 13Y, 13M, 13C, and 13K and the laser exposure device 17 constitute a latent image forming unit.

The developing devices 14Y, 14M, 14C, and 14K develop the electrostatic latent images on the photoconductive drums 12Y, 12M, 12C, and 12K. The developing devices 14Y, 14M, 14C, and 14K perform development using a two-component developer including a toner of each of the colors yellow (Y), magenta (M), cyan (C), and black (K), which is the developer, and a carrier.

The intermediate transfer belt 10 is stretched around a backup roller 21, a driven roller 20, and first to third tension rollers 22 to 24 so as to rotate in the direction indicated by arrow s.

The intermediate transfer belt 10 is formed of a polyimide belt having a thickness of 100 μm, in which carbon particles are uniformly dispersed. The intermediate transfer belt 10 has an electrical resistivity of 10⁹ Ωcm and exhibits semiconductive properties.

As a material for the belt, semiconductive materials having an electrical resistivity of 10⁸ to 10¹¹ Ωcm may be used. For example, in addition to the polyimide belt in which carbon particles are dispersed, belts made from polyethylene terephthalate, polycarbonate, polytetrafluoroethylene, polyfluorovinylidene, and the like in which conductive particles such as carbon particles are dispersed may be used. Moreover, polymer films of which the electrical resistance is adjusted by adjusting the compositions may be used without using conductive particles. Further, a material in which an ion conductive substance is mixed into this kind of polymer film, or a rubber member such as silicon rubber or urethane rubber having a relatively low electrical resistance may be used.

The intermediate transfer belt 10 faces and makes contact with the photoconductive drums 12Y, 12M, 12C, and 12K. At positions on the intermediate transfer belt 10 facing the photoconductive drums 12Y, 12M, 12C, and 12K, primary transfer rollers 18Y, 18M, 18C, and 18K are disposed. The primary transfer rollers 18Y, 18M, 18C, and 18K perform primary transfer so that the toner images formed on the photoconductive drums 12Y, 12M, 12C, and 12K are transferred to the intermediate transfer belt 10.

The photoconductor cleaners 16Y, 16M, 16C, and 16K neutralize the surface charge which remains on the photoconductive drums 12Y, 12M, 12C, and 12K after the primary transfer was performed. The photoconductor cleaners 16Y, 16M, 16C, and 16K remove and collect the residual toner on the photoconductive drums 12Y, 12M, 12C, and 12K.

A secondary transfer roller 27 is provided in a secondary transfer portion which is a transfer position at which the intermediate transfer belt 10 is supported by the backup roller 21. In the secondary transfer portion, a predetermined secondary transfer bias is applied to the backup roller 21. When a paper sheet passes between the intermediate transfer belt 10 and the secondary transfer roller 27, secondary transfer is carried out so that the toner images on the intermediate transfer belt 10 are transferred to the paper sheet. The paper sheet P is supplied from a sheet cassette 4 or a manual insertion mechanism 31. After the secondary transfer is performed, the intermediate transfer belt 10 is cleaned by a belt cleaner 10a.

A pickup roller 4a, a separation roller 28a, a transport roller 28b, and a registration roller pair 36 are provided in a path extending between the sheet cassette 4 and the secondary transfer roller 27. A manual pickup roller 31b and a manual separation roller 31c are provided in a path extending between a manual insertion tray 31a of the manual insertion mechanism 31 and the registration roller pair 36. In addition, a fixing device 30 is provided downstream of the secondary transfer portion along a vertical transport path 34. The fixing device 30 causes the toner images which were transferred to the paper sheet P at the secondary transfer portion to be fixed onto the paper sheet P. A gate 33 is provided downstream of the fixing device 30 so as to sort and guide the paper sheet towards a paper discharge roller 41 or a retransport unit 32. The paper sheet guided to the paper discharge roller 41 is discharged to a paper discharge portion 3. The paper sheet guided to the retransport unit 32 is guided again towards the secondary transfer roller 27.

The color printer 1 is provided with an environment sensor 38 that measures temperature, humidity, and the like which affect an image forming operation.

A color image forming operation of the color printer 1 having the above-described configuration will be described.

When the start of image formation is instructed, the photoconductive drum 12Y starts rotating upon receiving a driving force from a driving mechanism not shown. The electrification charger 13Y uniformly charges the photoconductive drum 12Y to approximately −600 V. The laser exposure device 17 irradiates the photoconductive drum 12Y, which was uniformly charged by the electrification charger 13Y with light corresponding to images to be recorded so as to form electrostatic latent images on the photoconductive drum 12Y. The developing device 14Y accommodates the developer (two-component developer: yellow (Y) toner+ferrite carrier) and forms a developing field between the photoconductive drum 12Y and the developing device 14Y by applying a bias voltage of −380 V to a developing sleeve using a developing bias voltage source. The negatively charged Y toner adheres onto the electrostatic latent images of the photoconductive drum 12Y.

Next, the developing device 14M develops the electrostatic latent images with a magenta developer and forms magenta toner (M toner) images on the photoconductive drum 12M. The M toner has the same average particle size of 7 μm as the Y toner. The M toner is charged to a negative polarity by friction charging with ferrite magnetic carrier particles (not shown) having an average particle size of approximately 50 μm. An average charge amount of the M toner is approximately −30 μC/g. The developing bias voltage is about −380 V similar to the developing device 14Y and is applied to the developing sleeve by the bias voltage source. That is, the developing device 14M has the same structure as the developing device 14Y. The developing field in the image portion is directed from the front surface of the photoconductive drum 12M to the developing sleeve, and the negatively charged M toner adheres onto a latent image potential portion.

In a Y (yellow) transfer region which is formed by the photoconductive drum 12Y, the intermediate transfer belt 10, and the primary transfer roller 18Y, a bias voltage of approximately +1000 V is applied to the primary transfer roller 18Y. A transfer field is formed between the primary transfer roller 18Y and the photoconductive drum 12Y, and the Y-toner image on the photoconductive drum 12Y is transferred to the intermediate transfer belt 10 in accordance with the transfer field.

The primary transfer roller will be described in further detail.

The primary transfer roller 18Y is a conductive foamed urethane roller in which carbon particles are dispersed so as to provide conductive properties. The primary transfer roller 18Y is a roller which has an outer diameter of φ18 mm and uses a core metal having a diameter of φ10 mm. The electrical resistance between the core metal and the roller surface is approximately 10⁶Ω. A constant direct-current voltage source is connected to the core metal.

A power feeding device of the transfer device is not limited to a roller but may be a conductive brush, a conductive rubber blade, a conductive sheet, or the like. The conductive sheet is a rubber member and a resin film in which carbon particles are dispersed, and may be rubber members such as silicon rubber, urethane rubber, and EPDM and resin members such as polycarbonate. The resistivity of the power feeding device is preferably 10⁵ to 10⁷ Ωcm.

A spring serving as an urging mechanism is provided at both ends of a roller shaft, and by this spring, the primary transfer roller 18Y is elastically moved in a vertical direction to make contact with the transport intermediate transfer belt 10. The magnitude of the urging force of the spring is 600 gf. Here, the urging force refers to the sum of the urging force of the springs arranged at both ends of the roller shaft.

The configurations of the primary transfer rollers 18M, 18C, and 18K are the same as the primary transfer roller 18Y. Moreover, the configuration in which the primary transfer roller 18Y is elastically brought into contact with the transport intermediate transfer belt 10 is the same as the primary transfer rollers 18M, 18C, and 18K. Therefore, description of the configurations of the primary transfer rollers 18M, 18C, and 18K will be omitted.

Images on the intermediate transfer belt 10 to which Y (yellow) toner images are transferred in a Y transfer region are transported toward an M (magenta) transfer region. In the M transfer region, when a bias voltage of approximately +1200 V is applied from a direct-current voltage source to the primary transfer roller 18M, M-toner images are transferred so as to overlap with the Y-toner images. When a bias voltage of approximately +1400 V is applied to the primary transfer roller 18C in a C (cyan) transfer region and a bias voltage of approximately +1600 V is applied to the primary transfer roller 18K in a K (black) transfer region, C-developer images and K-developer images are sequentially transferred so as to overlap with the developer images which were already transferred.

The multiple color toner images on the intermediate transfer belt 10 are moved to the secondary transfer portion as described above and secondarily transferred to a paper sheet.

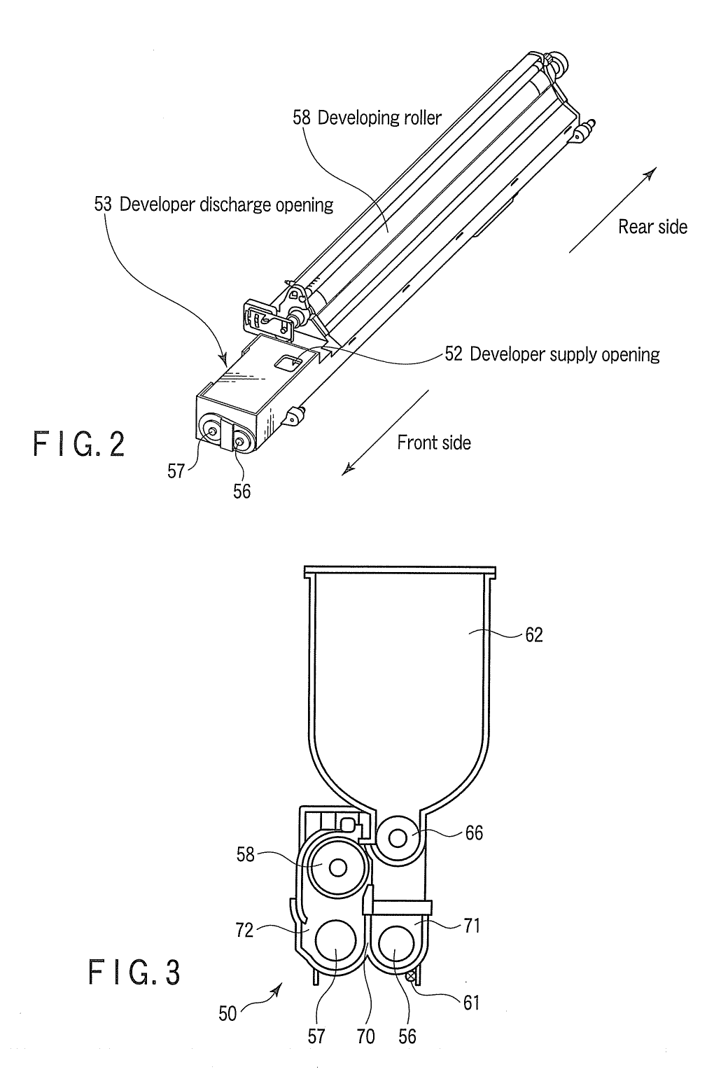

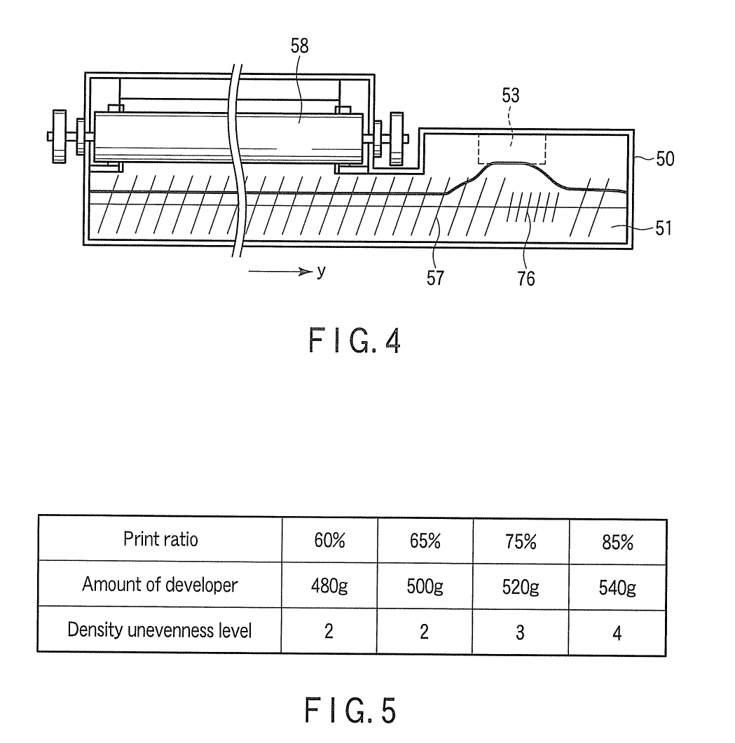

FIG. 2 is a perspective view showing an exemplary configuration of a developing device according to the embodiment. FIG. 3 is a sectional view showing an exemplary combination of a developing device and a toner supply hopper according to the embodiment. FIG. 4 is a sectional view illustrating an exemplary operation of developer in the developing device according to the embodiment. The developing devices 14Y, 14M, 14C, and 14K will be described with reference to FIGS. 1 to 4. Since the developing devices 14Y, 14M, 14C, and 14K have the same structure, the same reference numerals will be used for describing the respective developing devices.

A casing 50 accommodates developer 51 having a toner and a carrier. The developers 51 of the respective developing devices 14Y, 14M, 14C, and 14K have different colors. A developer supply opening 52 is formed on the upper portion on the front side of the casing 50. A toner supply hopper 62 is provided at the front side of the casing 50.

The developing device is provided with a toner density sensor 61 that measures permeability of the developer. When the toner density of the developer in the developing device decreases, toner is supplied from the toner supply hopper 62 shown in FIG. 3 into the developing device through the developer supply opening 52 so that the toner density in the developing device is maintained constant. Moreover, a carrier is also supplied into the developing device at the same time as the toner. A supply auger 66 is provided at the bottom of the toner supply hopper 62 so as to supply a new toner to the developer supply opening 52.

A developer discharge opening 53 which is a paper discharge portion is formed on the side surface on the front side of the casing 50. When the volume of the developer 51 in the casing 50 increases with the supply of new toner and carrier, surplus developer is discharged through the developer discharge opening 53 and collected. In this way, the amount of the developer 51 in the casing 50 is maintained constant. At the same time, in the developer 51 in the casing 50, old and deteriorated carrier is replaced with new carrier little by little.

The developing roller 58 is rotatably provided in the casing 50. The developing roller 58 supplies toner to the electrostatic latent images formed on the photoconductive drums 12Y, 12M, 12C, and 12K to form toner images. The interior of the casing 50 is partitioned along the axial direction of the photoconductive drums 12Y, 12M, 12C, and 12K by a partitioning plate 70.

The partitioning plate 70 partitions the interior of the casing 50 into a stirring and transport chamber 71 and a stirring and supply chamber 72. In the stirring and transport chamber 71, new toner and new carrier supplied through the developer supply opening 52 and the developer 51 which was already present in the casing 50 are stirred and transported towards the rear side by a first screw 56. In this way, the toner of the developer 51 is charged.

The developer 51 stirred and transported by the first screw 56 is supplied to the stirring and supply chamber 72 through an opening on the rear side of the partitioning plate 70. In the stirring and supply chamber 72, the developer 51 is stirred and transported toward the front side by a second screw 57 and supplied to the developing roller 58.

As shown in FIG. 4, a discharge screw 76 is formed on the front side of the second screw 57. The discharge screw 76 has a small screw diameter and a small screw pitch as shown in FIG. 4 so as to decrease the flow rate of the developer 51. Therefore, as shown by a solid line, the surface of the developer 51 transported in the direction indicated by arrow y piles up into a mountain shape. When the volume of the developer 51 in the casing 50 is equal to or smaller than a predetermined amount, the developer 51 is piled up by the discharge screw 76 but does not reach up to the developer discharge opening 53.

When toner and carrier are supplied from the toner supply hopper 62 in such a state, the volume of the developer 51 increases. Thus, the developer 51 which was piled up by the discharge screw 76 reaches up to the developer discharge opening 53. The developer 51 which arrived at the developer discharge opening 53 is discharged through the developer discharge opening 53. The developer discharge opening 53 is disposed so that the apex of the mountain shape of the developer 51 swollen by the discharge screw 76 coincides approximately with the central portion in the longitudinal direction of the developer discharge opening 53. Therefore, developer which overflows excessively with the supply of toner and carrier is discharged through the developer discharge opening 53. The developer 51 which passed through the discharge screw 76 is circulated and transported to the stirring and transport chamber 71 through an opening on the front side of the partitioning plate 70.

In this way, when a new developer 51 is supplied, overflowing developer 51 is discharged through the developer discharge opening 53, so that the amount of developer in the developing device is maintained constant. At the same time, old and deteriorated carrier in the developing device is replaced with new carrier little by little.

As described above, the amount of the developer 51 in the developing device depends on the supply rate of the developer 51 supplied from the toner supply hopper 62. Therefore, when images having a high print ratio (for example, a print ratio of 85%) are continuously printed on a number of pages, the supply rate of the developer 51 is fast, and a large amount of developer is supplied to the developing device in a short period. Here, the print ratio is defined as a ratio of a printing area to a target printing area.

FIG. 5 shows an exemplary evaluation result of a print ratio and image density unevenness according to the embodiment. It will be assumed that the initial amount of developer in the developing device is 400 g. Next, the amount of developer in the developing device after images were continuously printed on 10K pages was measured while changing the print ratio. The density unevenness of solid images on the fourth page when images were continuously printed on four pages in such a state was evaluated. The density unevenness was evaluated into five steps of levels 1 to 5. A density unevenness level 1 represents the highest evaluation result, and a density unevenness level 5 represents the lowest evaluation result. Moreover, density evaluation levels 1 and 2 represent allowable levels. At a print ratio of 60%, the amount of developer was 480 g and the density unevenness was evaluated as allowable level 2. At a print ratio of 65%, the amount of developer was 500 g and the density unevenness was evaluated as approximately allowable level 2. At a print ratio of 75%, the amount of developer was over 520 g and the density unevenness was evaluated as unallowable level 3. At a print ratio of 85%, the amount of developer was over 540 g and the density unevenness was evaluated as having deteriorated to level 4.

As described above, when images having a high print ratio are continuously printed on a number of pages, the supply rate of the developer 51 from the toner supply hopper 62 increases so that the amount of developer in the developing device increases. Particularly, when the amount of developer under the developing roller 58 increases, developer which was used once for development is supplied again for development as it is by the rotation of the developing roller 58. This phenomenon is one of the causes of image deterioration such as the density unevenness of solid images.

In the first embodiment, the supply ratio (described later) of the developer 51 is calculated every predetermined number of prints (α1 pages). When the calculated supply ratio exceeds a predetermined value (β1%), the rotation speed of a developer transport screw (the first and second screws 56 and 57) is increased by predetermined times (γ1 times) so as to be faster than those during the normal printing.

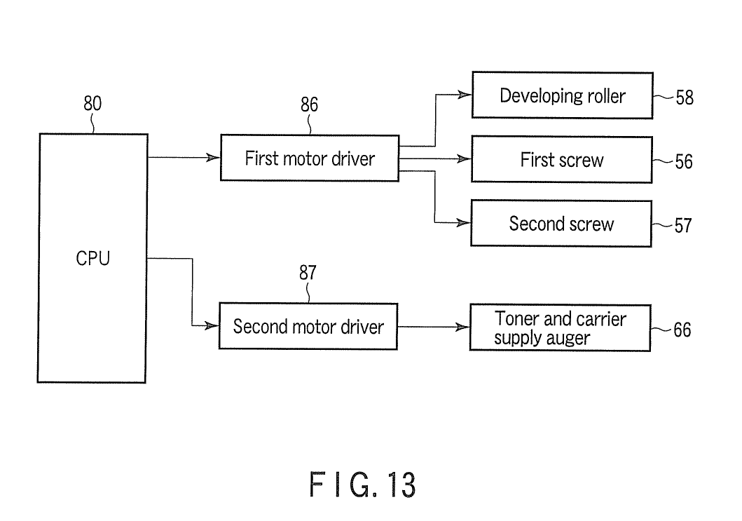

FIG. 13 is a block diagram showing an exemplary control system that controls the rotation speed of a transport screw of each developing device according to an embodiment. On the output side of a CPU 80 which is a control unit controlling the amount of carrier supply as well as an overall operation of the color printer 1, first and second motor drivers 86 and 87 are connected. The first motor driver 86 drives the developing roller 58 and a developer transport screw (the first and second screws 56 and 57). The second motor driver 87 drives a toner and carrier supply auger 66.

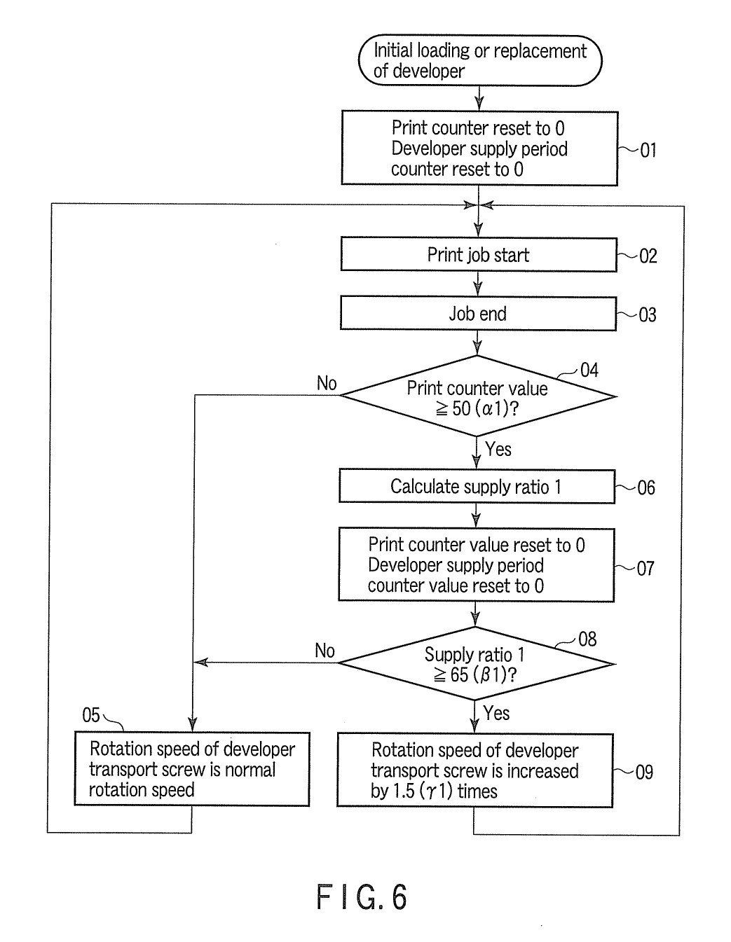

FIG. 6 is an exemplary flowchart showing a control method of the developing device according to the first embodiment. The flow shown in FIG. 6 is a process executed for each of the developing devices 14Y, 14M, 14C, and 14K.

In Act 01, the color printer 1 resets two counters, which are used for the control of the developing device, and which include a print counter and a developer supply period counter, to 0. The print counter counts the number of prints for each color. The print counter is incremented by 1 every one page of A4-horizontal sheet. When images are printed on A3-size sheet, the print counter is incremented by 2 every one page. The developer supply period counter counts the driving period of a driving motor for the supply auger 66 that supplies the developer 51 to the developing device for each color. The driving period counter is incremented by 1 every 12 msec, for example.

When the developer 51 of each developing device is replaced, the color printer 1 automatically resets the above-mentioned two counters by the initialization operation (for example, toner density adjustment) of each developing device. When automatic resetting is not possible, a user may manually reset the counters when replacing the developer 51.

In Act 02, the color printer 1 starts a print job. In Act 03, the color printer 1 executes a print sequence to complete the print job. In Act 04, a print counter value is acquired, and it is determined whether or not an accumulated number of prints is equal to or larger than a predetermined number of pages (α1 pages). The predetermined number of pages al is 50 pages, for example.

If No in Act 04, that is, when the accumulated number of prints does not reach the predetermined number of pages (α1 pages), the developer 51 in the developing device is transported at a normal rotation speed of the developer transport screw in Act 05. Then, the flow returns to Act 02, the color printer 1 waits for the next printing. At that time, the color printer 1 prepares for the next printing without resetting the two counters. The count values are integrated when the next printing is executed.

If Yes in Act 04, that is, when the accumulated number of prints is equal to or larger than the predetermined number of pages (α1 pages), the developer supply period counter value is acquired, and a supply ratio 1 is calculated using the equations below. The developer supply period counter value corresponds to the amount of developer supplied into the developing device. Therefore, the supply ratio 1 is a value corresponding to an average increase in the amount of developer per one page of print.

(Y)Supply Ratio 1=(Y) Developer Supply Period Counter Value/(Y) Print Counter Value

(M) Supply Ratio 1=(M) Developer Supply Period Counter Value/(M) Print Counter Value

(C) Supply Ratio 1=(C) Developer Supply Period Counter Value/(C) Print Counter Value (K) Supply Ratio 1=(K) Developer Supply Period Counter Value/(K) Print Counter Value

After the print ratio 1 is calculated, the two counter values are reset to 0 in Act 07. In Act 08, it is determined whether or not the calculated supply ratio 1 is equal to or larger than a predetermined value (β1).

If No in Act 08, that is, when the supply ratio 1 does not reach the predetermined value (β1), the developer 51 in the developing device is transported at a normal rotation speed of the developer transport screw in Act 05. Then, the flow returns to Act 02, the color printer 1 waits for the next printing. When the next printing is executed, the counter value is reset to 0.

If Yes in Act 08, that is, when the supply ratio 1 is equal to or larger than the predetermined value (β1), the rotation speed of the developer transport screw of the developing device of that color is increased by predetermined times (γ1 times) than that during the normal printing in Act 09. The predetermined times γ1 is 1.5 times, for example. Then, the flow returns to Act 02, the color printer 1 waits for the next printing. When the next printing is executed, the counter value is reset to 0. The changed rotation speed of the screw is continued until the next determination is made, that is, until a predetermined number of pages (α1 pages) were subsequently printed.

In the first embodiment, the supply ratio is calculated and the rotation speed of the screw is controlled every predetermined number of prints (α1 pages). It is practical to increase the rotation speed of the screw by about 2 times or less. If the rotation speed is increased above that value, there is an adverse effect in that a disturbance of the developer results in deterioration of image quality.

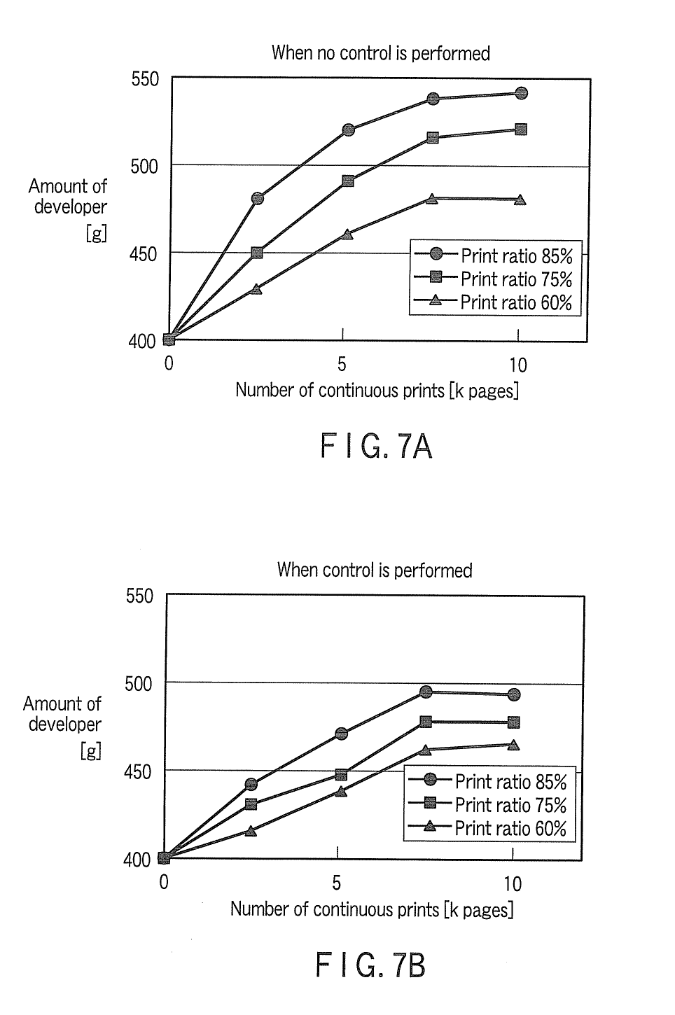

The results of the application of the first embodiment will be described. FIG. 7A is an exemplary diagram showing the number of prints and the amount of developer in the developing device for each print ratio when no control is performed according to the embodiment. FIG. 7B is an exemplary diagram showing the number of prints and the amount of developer in the developing device for each print ratio when control is performed according to the embodiment.

As shown in FIG. 7B, when the increase in the amount of developer is large because of the loading of the developer, by performing control so as to increase the rotation speed of the developer transport screw (for example, by 1.5 times) to increase the discharge amount, the amount of developer in the developing device becomes equal to or smaller than 500 g. Thus, the increase in the amount of developer is suppressed compared to the case shown in FIG. 7A.

By doing so, even when toner and carrier are supplied at the time of printing images having a high print ratio, it is possible to accelerate the discharge of the developer and prevent congestion of the developer under the developing roller. Moreover, by maintaining the amount of developer in the developing device to be within an allowable range at an average print ratio of up to 85%, it is possible to maintain good image quality such that the density unevenness is evaluated as level 2.

Next, a control method of a second embodiment will be described.

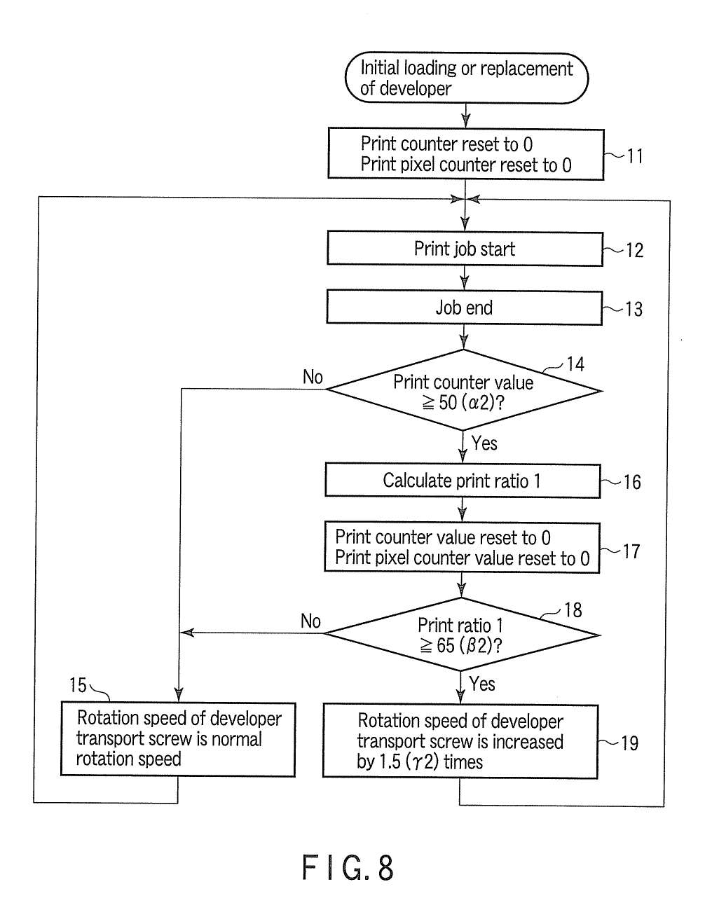

FIG. 8 is an exemplary flowchart showing a control method of a developing device according to the second embodiment. The second embodiment is different from the first embodiment in that control is performed using a print ratio which is calculated from the print counter value and a print pixel counter value. Therefore, the same portions as the first embodiment will be denoted by the same reference numerals, and detailed description thereof will be omitted.

The processes of Acts 11 to 13 are the same as those of the first embodiment, and description thereof will be omitted. In Act 14, the print counter value is acquired, and it is determined whether or not an accumulated number of prints is equal to or larger than a predetermined number of pages (α2 pages). The predetermined number of pages α2 is 50 pages, for example.

When the accumulated number of prints does not reach the predetermined number of pages (α2 pages), the developer 51 in the developing device is transported at a normal rotation speed of the developer transport screw in Act 15. When the accumulated number of prints is equal to or larger than the predetermined number of pages (α2 pages), the print pixel counter value is acquired, and a print ratio 1 is calculated using the equations below. Here, the print pixel counter value is the number of pixels on a sheet to which toner is transferred.

On the other hand, the print pixel counter value is a value corresponding to the amount of toner consumed, and therefore, corresponds to the amount of developer supplied into the developing device. Therefore, similarly to the supply ratio 1, the print ratio 1 is a value corresponding to an average increase in the amount of developer per one page of print.

(Y) Print Ratio 1=(Y) Print Pixel Counter Value/(Y) Print Counter Value

(M) Print Ratio 1=(M) Print Pixel Counter Value/(M) Print Counter Value

(C) Print Ratio 1=(C) Print Pixel Counter Value/(C) Print Counter Value

(K) Print Ratio 1=(K) Print Pixel Counter Value/(K) Print Counter Value

In Act 18, it is determined whether or not the calculated print ratio 1 is equal to or larger than a predetermined value (β2). When the print ratio 1 does not reach the predetermined value (β2), the developer 51 in the developing device is transported at a normal rotation speed of the developer transport screw in Act 15. When the print ratio 1 is equal to or larger than the predetermined value (β2), the rotation speed of the developer transport screw of the developing device of that color is increased by predetermined times (γ2 times) than those during the normal printing in Act 19. The predetermined times γ2 is 1.5 times, for example.

In the second embodiment, similarly to the first embodiment, it is possible to prevent deterioration of image quality caused by density unevenness by suppressing an increase in the amount of developer.

Next, a control method of a third embodiment will be described.

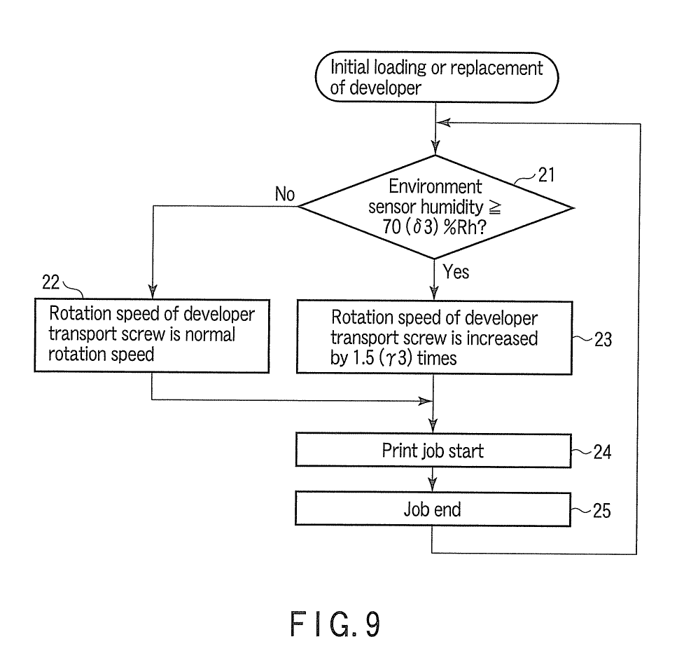

FIG. 9 is an exemplary flowchart showing a control method of a developing device according to the third embodiment. In the third embodiment, humidity is measured by the environment sensor 38 provided in the image forming apparatus, and the rotation speed of the developer transport screw is controlled.

In Act 21, a humidity value measured by the environment sensor 38 is acquired, and it is determined whether or not the relative humidity is equal to or higher than a predetermined value (83%). The predetermined value δ3 is 70% RH, for example. When the relative humidity is equal to or higher than 70% RH, for example, the developer 51 becomes damp, so that the charge amount thereof will decrease and the mobility thereof will deteriorate. As a result, the transport property of the developer 51 in the developing device will deteriorate, and the amount of developer will increase. Accordingly, a problem of image quality deterioration is likely to occur.

When the relative humidity does not reach the predetermined value (δ3%), the developer 51 in the developing device is transported at a normal rotation speed of the developer transport screw in Act 22. When the relative humidity is equal to or higher than the predetermined value (δ3%), the rotation speed of the developer transport screw is increased by predetermined times (γ3 times) than that during the normal printing in Act 23. The predetermined times γ3 is 1.5 times, for example.

When a print start command is input, the color printer 1 starts a print job in Act 24 and executes a print sequence to complete the print job in Act 25. Then, the operations starting with Act 21 are executed.

Next, a control method according to a modification of the third embodiment will be described.

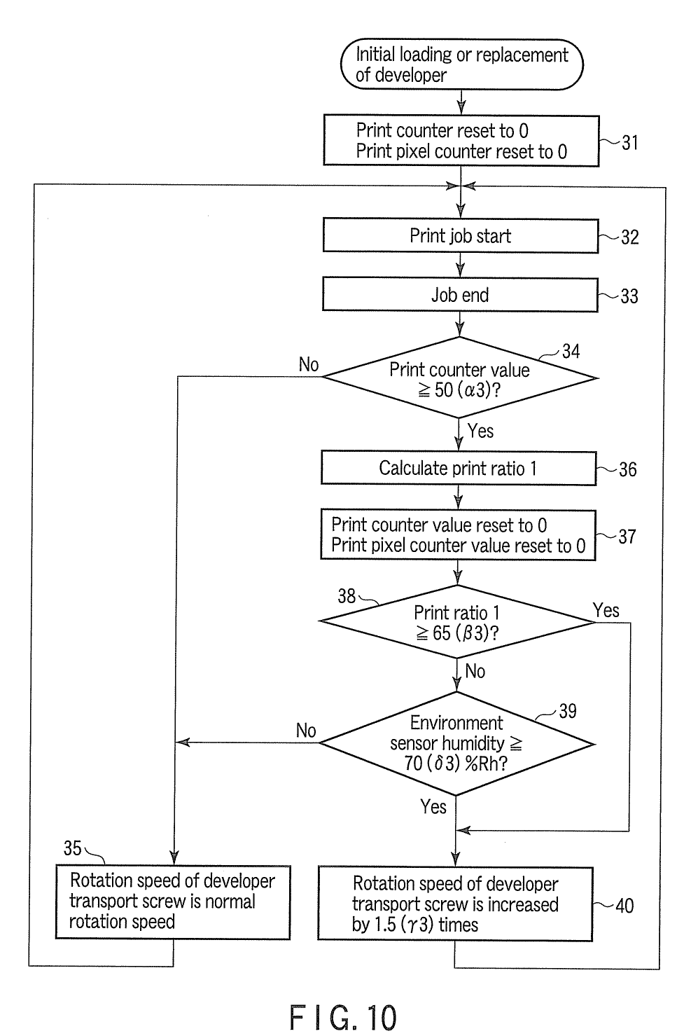

FIG. 10 is an exemplary flowchart showing a control method of a developing device according to a modification of the third embodiment. In the control method of the modification, control is performed using a combination of the humidity value measured by the environment sensor 38 and the print ratio 1 described in the second embodiment.

The processes of Acts 31 to 37 are the same as those of Acts 11 to 17 in FIG. 8, and description thereof will be omitted. In Act 38, it is determined whether or not the calculated print ratio 1 is equal to or larger than a predetermined value (β3).

When the print ratio 1 does not reach the predetermined value (β3), the humidity value measured by the environment sensor 38 is acquired, and it is determined whether or not the relative humidity is equal to or higher than a predetermined value (δ3%) in Act 39. The predetermined value δ3 is 70% RH, for example. When the relative humidity does not reach the predetermined value (δ3%), the developer 51 in the developing device is transported at a normal rotation speed of the developer transport screw in Act 35. When the relative humidity is equal to or higher than the predetermined value (δ3%), the rotation speed of the developer transport screw is increased by predetermined times (γ3 times) than that during the normal printing in Act 40. The predetermined times γ3 is 1.5 times, for example.

In the third embodiment, by using the measured value of the environment sensor 38, it is possible to suppress the increase in the amount of developer in a more sensitive way. The control may be performed based on a combination of the humidity value measured by the environment sensor 38 and the supply ratio 1 described in the first embodiment.

Next, a control method of a fourth embodiment will be described.

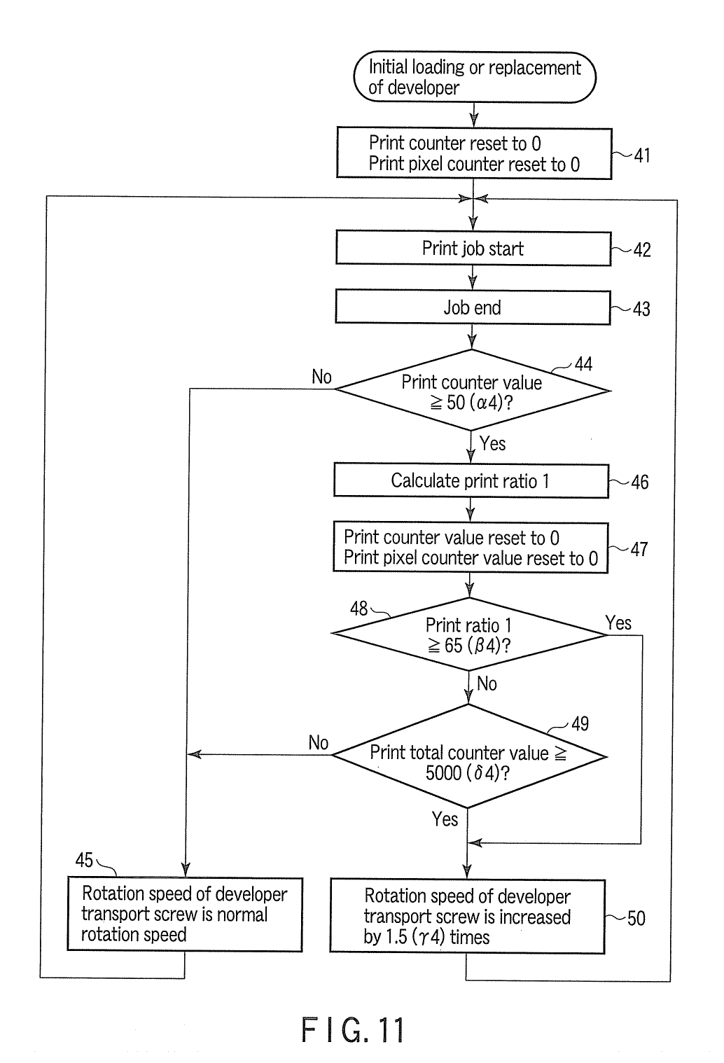

FIG. 11 is an exemplary flowchart showing a control method of a developing device according to the fourth embodiment. In the fourth embodiment, control is performed using an accumulated number of prints from the loading (replacement) of a developing device. The same portions as the first to third embodiments will be denoted by the same reference numerals, and detailed description thereof will be omitted.

In Act 41, the color printer 1 resets three counters, which are used for the control of the developing device, and which include a print counter, a print pixel counter, and a print total counter, to 0. The print total counter counts an integrated value of the number of prints from the loading (replacement) of the developing device.

The processes of Acts 42 to 47 are the same as those of Acts 32 to 37 in FIG. 10, and description thereof will be omitted. In Act 48, it is determined whether or not the calculated print ratio 1 is equal to or larger than a predetermined value (β4).

When the print ratio 1 does not reach the predetermined value (β4), the print total counter value is acquired, and it is determined whether or not the counter value is equal to or larger than a predetermined number of pages (δ4 pages) in Act 49. The predetermined number of pages δ4 is 5000 pages, for example. When developer is used for a long period, for example, when the number of prints becomes equal to or larger than 5000 pages, the mobility of the developer decreases, and transport is likely to be slowed down.

Therefore, when the counter value does not reach the predetermined number of pages (δ4 pages), the developer 51 in the developing device is transported at a normal rotation speed of the developer transport screw in Act 45. When the counter value is equal to or larger than the predetermined number of pages (δ4 pages), the rotation speed of the developer transport screw is increased by predetermined times (γ4 times) than those during the normal printing in Act 50. The predetermined times γ4 is 1.5 times, for example.

The control may be performed based on a combination with the developer supply ratio and the print ratio described in the first or second embodiment or the environment sensor value described in the third embodiment. For example, when the print total counter value is equal to or larger than a predetermined number of pages (for example, 5000 pages) and the supply ratio is equal to or larger than a predetermined value, the rotation speed of the developer transport screw may be increased by predetermined times (for example, 1.5 times) than those during the normal printing. Moreover, when the print total counter value is equal to or larger than a predetermined number of pages (for example, 5000 pages) and the humidity is equal to or higher than a predetermined value (for example, 75% RH), the rotation speed of the developer transport screw may be increased by predetermined times (for example, 1.5 times) than that during the normal printing.

Next, a control method of a fifth embodiment will be described.

In the fifth embodiment, control when the amount of toner supply is small will be described. When the amount of toner supply is small, the developer will be slowly discharged and consumed. In that case, the image quality will deteriorate as the developer is consumed. Therefore, control is performed so as to decrease the rotation speed of the developer transport screw based on the supply ratio described in the first embodiment or the print ratio described in the second embodiment. By doing so, it is possible to prevent deterioration of image quality.

For example, in a process corresponding to Act 08 in FIG. 6, it is determined whether or not the supply ratio 1 is smaller than a predetermined lower limit. When the supply ratio 1 is smaller than the predetermined lower limit, the rotation speed of the developer transport screw is increased by predetermined times (value smaller than 1, for example, 0.7 times) than that during the normal printing. Similar control can be performed when the print ratio is used.

Next, a control method of a sixth embodiment will be described.

In the sixth embodiment, control when the humidity measured by the environment sensor 38 is low will be described. When the humidity measured by the environment sensor 38 is low, the charge amount of the developer 51 will increase and the mobility thereof will improve. As a result, a relatively large amount of developer will be discharged compared to normal humidity. Therefore, when the humidity is equal to or lower than a predetermined lower limit (for example, 30% RH), the rotation speed of the developer transport screw is increased by predetermined times (value smaller than 1, for example, 0.7 times) than that during the normal printing. In this way, it is possible to prevent deterioration of image quality caused by a decrease in the amount of developer.

For example, in a process corresponding to Act 39 in FIG. 10, it is determined whether or not the humidity value is lower than a predetermined lower limit. When the humidity value is lower than the predetermined lower limit, the rotation speed of the developer transport screw is increased by predetermined times (value smaller than 1, for example, 0.7 times) than that during the normal printing.

Next, a control method of a seventh embodiment will be described.

In the seventh embodiment, the control method when the amount of toner supply is small described in the fifth and sixth embodiments is combined with the control method when the amount of toner supply is large described in the first to fourth embodiments.

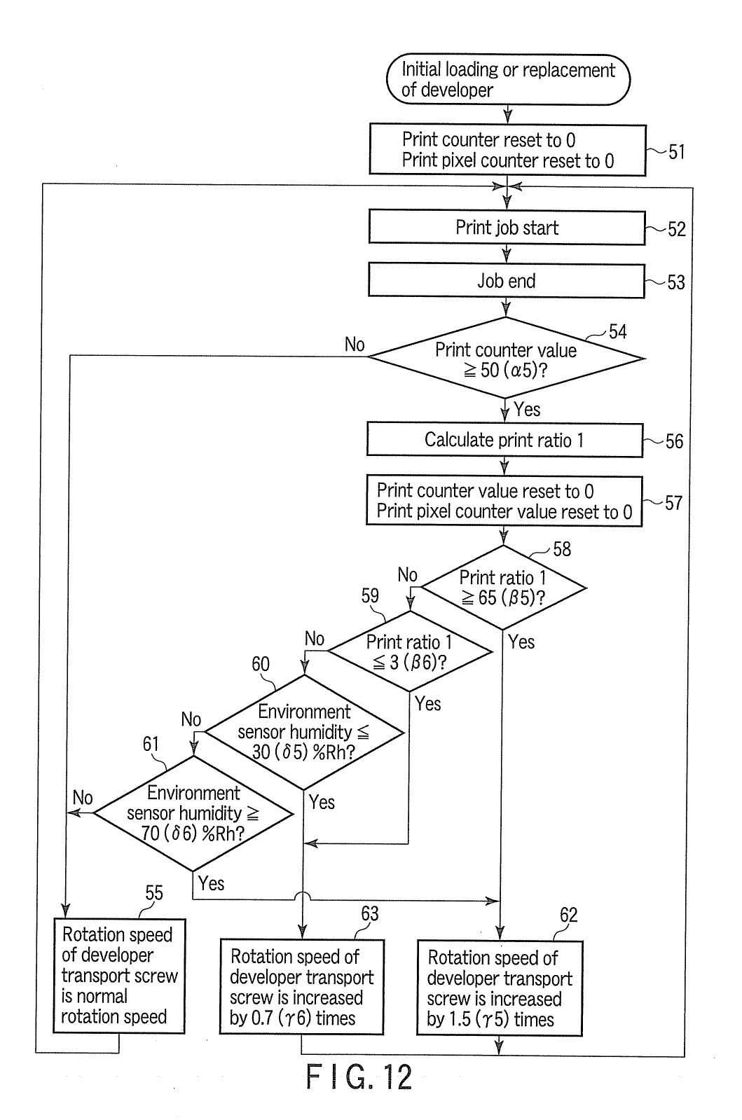

FIG. 12 is an exemplary flowchart showing a control method of a developing device according to the seventh embodiment. The processes of Acts 51 to 58 are the same as those of Acts 11 to 18 in FIG. 8, and description thereof will be omitted.

In Act 58, it is determined whether or not the calculated print ratio 1 is equal to or larger than a predetermined value (β5). When the print ratio 1 is equal to or larger than the predetermined value (β5), the rotation speed of the developer transport screw of the developing device of that color is increased by predetermined times (γ5 times) than that during the normal printing in Act 62. The predetermined times γ5 is larger than 1 and is 1.5, for example. When the print ratio 1 does not reach the predetermined value (β5), it is determined in Act 59 whether or not the calculated print ratio 1 is equal to or smaller than a predetermined value (β6). When the print ratio 1 is equal to or smaller than the predetermined value (β6), that is, if the print ratio 1 is in the range of β5 to β6, the rotation speed of the developer transport screw of the developing device of that color is increased by predetermined times (γ6 times) than that during the normal printing in Act 63. Here, the predetermined times γ6 is smaller than 1 and is 0.7, for example.

When the print ratio 1 is larger than the predetermined value (β6), the humidity value measured by the environment sensor 38 is acquired, and it is determined whether or not the relative humidity is equal to or lower than a predetermined value (δ5%) in Act 60. The predetermined value δ5 is 30% RH, for example. When the relative humidity is equal to or lower than the predetermined value (δ5%), the rotation speed of the developer transport screw of the developing device of that color is increased by predetermined times (γ6 times) than that during the normal printing in Act 63.

When the relative humidity is higher than the predetermined value (δ5%), it is determined in Act 61 whether or not the relative humidity is equal to or higher than a predetermined value (δ6%). The predetermined value δ6 is 70% RH, for example. When the relative humidity is equal to or higher than the predetermined value (δ6%), the rotation speed of the developer transport screw of the developing device of that color is increased by predetermined times (γ5 times) than that during the normal printing in Act 62. When the relative humidity is lower than the predetermined value (δ6%), the developer 51 in the developing device is transported at a normal rotation speed of the developer transport screw in Act 55.

According to the seventh embodiment, it is possible to perform control so as to cope with various cases including a case where the amount of toner supply is large, a case where the amount of toner supply is small, and a case where toner properties are changed.

In any of the above-described embodiments, it is possible to maintain the amount of developer to be within a predetermined range and maintain good image quality without density unevenness of solid images.

Moreover, in the present embodiments, only the rotation speed of the transport screw is changed without changing the rotation speed of the developing roller. Therefore, printing can be performed even when the control of the present embodiments is being executed. Further, since the rotation speed is frequently controlled even when printing is being executed, no downtime will take place in the printing operation.

The respective functions described in the above embodiments may be configured using hardware and may be realized using software by causing a computer to read a program describing the respective functions. Moreover, the respective functions may be configured by appropriately selecting any of software and hardware.

In addition, the respective functions can be realized by causing a computer to read a program stored in a recording medium not shown. The recording medium used in the present embodiments may have any recording format as long as it is capable of recording a program and is a computer-readable recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a supply device that supplies developer comprising toner and carrier;
a developing device configured to accommodate the developer comprising toner and carrier in a manner that the developer is stirred and transported therein, and configured to discharge the developer in an overflow manner through a discharge opening;
a screw that stirs and transports the developer in the developing device; and
a control unit configured to change the rotation speed of the screw based on a predetermined index which varies in accordance with supply and consumption of the developer or an environmental condition when development is performed.

2. The apparatus according to claim 1,
wherein the control unit increases the rotation speed of the screw to be faster than a predetermined rotation speed when the index is equal to or larger than a first value, and
wherein the control unit changes the rotation speed of the screw to the predetermined rotation speed when the index is smaller than the first value.

3. The apparatus according to claim 1,
wherein the control unit decreases the rotation speed of the screw to be slower than a predetermined rotation speed when the index is equal to or smaller than a second value, and
wherein the control unit changes the rotation speed of the screw to the predetermined rotation speed when the index is larger than the second value.

4. The apparatus according to claim 1,
wherein the index is a period over which the developer is supplied by the supply device.

5. The apparatus according to claim 1,
wherein the index is a printing area which is an integrated value of a laser exposure signal that forms a toner image.

6. The apparatus according to claim 1, further comprising a humidity sensor configured to measure an environmental humidity of the image forming apparatus,
wherein the control unit controls the amount of developer in the developing device by changing the rotation speed of the screw based on the index and the humidity.

7. The apparatus according to claim 6,
wherein the control unit increases the rotation speed of the screw to be faster than a predetermined rotation speed when the index is equal to or larger than a first value,
wherein the control unit increases the rotation speed of the screw to be faster than the predetermined rotation speed when the index is smaller than the first value and the humidity is higher than a second humidity value, and
wherein the control unit changes the rotation speed of the screw to the predetermined rotation speed when the index is smaller than the first value and the humidity is equal to or lower than the second humidity value.

8. The apparatus according to claim 6,
wherein the control unit increases the rotation speed of the screw to be faster than a predetermined rotation speed when the index is equal to or larger than a first value,
wherein the control unit decreases the rotation speed of the screw to be slower than the predetermined rotation speed when the index is equal to or smaller than a second value which is smaller than the first value,
wherein the control unit decreases the rotation speed of the screw to be slower than the predetermined rotation speed when the index has a value between the first and second values and the humidity is equal to or lower than a first humidity value,
wherein the control unit increases the rotation speed of the screw to be faster than the predetermined rotation speed when the index has the value between the first and second values and the humidity is equal to or higher than a second humidity value which is higher than the first humidity value, and
wherein the control unit changes the rotation speed of the screw to the predetermined rotation speed when the index has the value between the first and second values and the humidity has a value between the first and second humidity values.

9. The apparatus according to claim 1, further comprising an index acquisition unit configured to acquire an integrated index corresponding to an integrated value of the number of prints printed after the developer of the developing device was renewed completely,
wherein the control unit controls the amount of developer in the developing device by changing the rotation speed of the screw based on the index and the integrated index.

10. The apparatus according to claim 9,
wherein the control unit increases the rotation speed of the screw to be faster than a predetermined rotation speed when the index is equal to or larger than a first value,
wherein the control unit increases the rotation speed of the screw to be faster than the predetermined rotation speed when the index is smaller than the first value and the integrated index is larger than a second value, and
wherein the control unit changes the rotation speed of the screw to the predetermined rotation speed when the index is smaller than the first value and the integrated index is equal to or smaller than the second value.

11. An image forming method of an image forming apparatus including a supply device configured to supply developer comprising toner and carrier, a developing device configured to accommodate the developer comprising toner and carrier in a manner that the developer is stirred and transported therein, and configured to discharge the developer in an overflow manner through a discharge opening, and a screw configured to stir and transport the developer in the developing device,
wherein a rotation speed of the screw is changed based on a predetermined index which varies in accordance with supply and consumption of the developer or an environmental condition when development is performed.

12. The method according to claim 11,
wherein the amount of developer is controlled by increasing the rotation speed of the screw to be faster than a predetermined rotation speed when the index is equal to or larger than a first value, and
wherein the amount of developer is controlled by changing the rotation speed of the screw to the predetermined rotation speed when the index is smaller than the first value.

13. The method according to claim 11,
wherein the amount of developer is controlled by decreasing the rotation speed of the screw to be slower than a predetermined rotation speed when the index is equal to or smaller than a second value, and
wherein the amount of developer is controlled by changing the rotation speed of the screw to the predetermined rotation speed when the index is larger than the second value.

14. The method according to claim 11,
wherein the index is a period over which the developer is supplied by the supply device.

15. The method according to claim 11,
wherein the index is a printing area which is an integrated value of a laser exposure signal that forms a toner image.

16. The method according to claim 11,
wherein the image forming apparatus further includes a humidity sensor configured to measure an environmental humidity of the image forming apparatus, and
wherein the amount of developer in the developing device is controlled by changing the rotation speed of the screw based on the index and the humidity.

17. The method according to claim 16,
wherein the amount of developer is controlled by increasing the rotation speed of the screw to be faster than a predetermined rotation speed when the index is equal to or larger than a first value,
wherein the amount of developer is controlled by increasing the rotation speed of the screw to be faster than the predetermined rotation speed when the index is smaller than the first value and the humidity is higher than a second humidity value, and
wherein the amount of developer is controlled by changing the rotation speed of the screw to the predetermined rotation speed when the index is smaller than the first value and the humidity is equal to or lower than the second humidity value.

18. The method according to claim 16,
wherein the amount of developer is controlled by increasing the rotation speed of the screw to be faster than a predetermined rotation speed when the index is equal to or larger than a first value,
wherein the amount of developer is controlled by decreasing the rotation speed of the screw to be slower than the predetermined rotation speed when the index is equal to or smaller than a second value which is smaller than the first value,
wherein the amount of developer is controlled by decreasing the rotation speed of the screw to be slower than the predetermined rotation speed when the index has a value between the first and second values and the humidity is equal to or lower than a first humidity value,
wherein the amount of developer is controlled by increasing the rotation speed of the screw to be faster than the predetermined rotation speed when the index has the value between the first and second values and the humidity is equal to or higher than a second humidity value which is higher than the first humidity value, and
wherein the amount of developer is controlled by changing the rotation speed of the screw to the predetermined rotation speed when the index has the value between the first and second values and the humidity has a value between the first and second humidity values.

19. The method according to claim 11,
wherein the image forming apparatus further includes an index acquisition unit configured to acquire an integrated index corresponding to an integrated value of the number of prints printed after the developer of the developing device was renewed completely, and
wherein the amount of developer in the developing device is controlled by changing the rotation speed of the screw based on the index and the integrated index.

20. The method according to claim 19,
wherein the amount of developer is controlled by increasing the rotation speed of the screw to be faster than a predetermined rotation speed when the index is equal to or larger than a first value,
wherein the amount of developer is controlled by increasing the rotation speed of the screw to be faster than the predetermined rotation speed when the index is smaller than the first value and the integrated index is larger than a second value, and
wherein the amount of developer is controlled by changing the rotation speed of the screw to the predetermined rotation speed when the index is smaller than the first value and the integrated index is equal to or smaller than the second value.
